(19) United States
(12) Patent Application Publication
(10) Pub. No.: US 2017/0264577 A1
(43) Pub. Date: Sep. 14, 2017

(54) A METHOD AND SYSTEM FOR PROCESSING AN ELECTRONIC MESSAGE

(71) Applicant: YANDEX EUROPE AG, Luzern (CH)

(72) Inventors: Egor Vladimirovich GANIN, Podolskiy district, Moscow region (RU); Anna Aleksandrovna DEMYANENKO, Rostov-on-Don, Rostov region (RU)

(21) Appl. No.: 15/504,761

(22) PCT Filed: Feb. 2, 2016
(86) PCT No.: PCT/IB16/50523

§ 371 Date: Feb. 17, 2017

(30) Foreign Application Priority Data
May 25, 2015 (RU) 2015119792

(51) Int. Cl. H04L 12/58; G06F 3/0482; H04L 29/08

(52) U.S. Cl. CPC H04L 51/063; H04L 67/36; H04L 51/02; H04L 51/22; H04L 51/30; G06F 3/0482; H04L 51/28

(57) ABSTRACT

A method and system for processing an electronic message that has steps of receiving the electronic message destined for a user being unintelligible to the user; parsing the electronic message which is a bounce message; determining at least one remedial action based on the parsed bounce message; generating a modified electronic message comprising at least a first interface element for displaying to the user an indication of the remedial action in a form that is intelligible to the user; and transmitting the modified electronic message. The content representation of the modified electronic message may be visually distinguishable in the inbox view of the mail service associated with the user. The first interface element may be configured to execute a remedial action and\or display an additional indication of the remedial action.

### CROSS-REFERENCE

The present application claims priority to Russian Patent Application No 2015119792, filed May 25, 2015, entitled “A METHOD AND SYSTEM FOR PROCESSING AN ELECTRONIC MESSAGE” the entirety of which is incorporated herein.

### FIELD OF TECHNOLOGY

The present technology relates to bounce messaging, and more specifically to optimizing the presentation thereof to a user.

### BACKGROUND

When an attempt to send an electronic message, such as an email, from a sender to a recipient is unsuccessful, the electronic message is said to have “bounced.” The term “bounce” refers to the event of failing to successfully deliver an electronic message to a recipient. A recipient refers to any destination, such as an email address, identified in an electronic message that should receive the electronic message when the electronic message is delivered. A recipient that was sent an electronic message, but did not receive the electronic message because the electronic message bounced is known as a “bounced recipient.”

When a sender initiates delivery of an electronic message to a recipient, the sender's mail server sends the electronic message to the recipient's mail server over a network, e.g., the Internet, and thereafter the recipient's mail server delivers the electronic message to the recipient. If the recipient's mail server is not able to deliver the message to the recipient, the recipient's mail server may deliver an electronic message rejection response (also known as a bounce message) to the sender's mail server. There are many reasons why an e-mail may bounce. One reason is that the recipient address is misspelled, or simply does not exist in the receiving system. Other reasons include resource exhaustion, such as a full disk, or the rejection of the message due to spam filters.

A bounced electronic message is a message that indicates that a particular recipient did not receive a particular electronic message delivered to the recipient. Depending on the configuration of the sender's mail server, a bounce message may also appear as a new message in the sender's inbox view when an electronic message sent by the sender is bounced.

The problem which is common with bounce messages is that they are generated automatically, sent from an unknown mailer-daemon address and contains the service text, which is unintelligible to an unsophisticated user. This typically causes a considerable amount of messages being not delivered while the user remains unaware of the reasons why the electronic message did not reach the recipient

### SUMMARY

It is an object of the present technology to ameliorate at least some of the inconveniences present in the prior art.

According to one aspect of the present technology, there is provided a method of processing an electronic message, the method executable on a server, the server coupled to an electronic device via a communication network, the electronic device associated with a user. The method comprises receiving the electronic message destined for the user, the electronic message being a bounce message, the electronic message including a content portion that is unintelligible to the user in regard to an indication of an error type that caused the bounce message to have been generated; parsing the bounce message by applying at least parsing process to determine the error type; based on the error type, determining at least one remedial action associated with the error type; generating a modified electronic message, the modified electronic message comprising at least a first interface element for displaying to the user an indication of the remedial action in a form that is intelligible to the user; and transmitting to the electronic device the modified electronic message.

In some implementation of the method, the modified electronic message further comprises at least one of a first portion of the content portion and a second portion of the content portion of the bounce message.

In some implementation of the method, the method further comprises receiving from the electronic device an indication of the user actuating the first interface element; executing the remedial action in association with the electronic message; and transmitting to the electronic device a confirmation of the remedial action having been executed.

In some implementation of the method, the first interface element is further configured to display to the user an additional indication of the at least one remedial action, the additional indication of the at least one remedial action is in a form that is intelligible to the user.

In some implementation of the method, the method comprises, before executing the remedial action, sending a trigger to the electronic device, the trigger is for displaying to the user an original electronic message, the original electronic message is a message that caused generation of the bounce message.

In some implementation of the method, the trigger is configured to cause the electronic device to display the original electronic message in a user-editable form.

In some implementation of the method, the trigger is sent as part of the modified electronic message.

In some implementation of the method, the error type is at least one of: a wrong destination address; a rejection as spam; an original electronic message exceeding allowed size for a recipient; an original electronic message containing malware; a blocked recipients' e-mail address; a full recipients' mailbox; a recipients' server error; and blocked IP-address.

In some implementation of the method, the modified electronic message further comprises a second interface element associated with at least one other action.

In some implementation of the method, the at least one other action is deleting the modified electronic message.

In some implementation of the method, the transmitting to the electronic device the modified electronic message causes the electronic device to display a content representation of the modified electronic message to the user, the modified electronic message including the first interface element.

In some implementation of the method, the transmitting to the electronic device the modified electronic message causes the electronic device to display the first interface element in an inbox view, the inbox view displays at least one indication of the modified electronic message that is visually distinguishable from the at least one other electronic message.

In some implementation of the method, the first interface element is for allowing the user to execute the remedial action directly from the inbox view without opening the modified electronic message.

In some implementation of the method, the method further comprises determining that the electronic message is a bounce message.

In some implementation of the method, generating the modified electronic message further comprises generating commands for displaying at least the first interface element.

According to one aspect of the present technology, there is provided a server for processing an electronic message, the server comprises a processor; and a tangible computer readable storage medium in communication with the processor and storing instructions that cause the processor to: receive the electronic message destined for the user, the electronic message is a bounce message, the electronic message includes a content portion that is unintelligible to the user in regard to an indication of an error type that caused the bounce message to have been generated; parse the bounce message by applying at least parsing process to determine the error type; based on the error type, determine at least one remedial action associated with the error type; generate a modified electronic message, the modified electronic message comprises at least a first interface element for displaying to the user an indication of the remedial action in a form that is intelligible to the user; and transmit to the electronic device the modified electronic message.

In some implementations of the server, the modified electronic message further comprises at least one of a first portion of the content portion and a second portion of the content portion of the bounce message.

In some implementations of the server, the server is further configured to receive from the electronic device an indication of the user actuating the first interface element; execute the remedial action in association with the electronic message; and transmit to the electronic device a confirmation of the remedial action having been executed.

In some implementations of the server, the first interface element is further configured to display to the user an additional indication of the at least one remedial action, the additional indication of the at least one remedial action is in a form that is intelligible to the user.

In some implementations of the server, before executing the remedial action, the server further sends a trigger to the electronic device, the trigger for displaying to the user an original electronic message, the original electronic message is a message that caused generation of the bounce message.

In some implementations of the server, the trigger is further configured to cause the electronic device to display the original electronic message in a user-editable form.

In some implementations of the server, the trigger is sent as part of the modified electronic message.

In some implementations of the server, the error type is at least one of: a wrong destination address; a rejection as spam; an original electronic message exceeding allowed size for a recipient; an original electronic message containing malware; a blocked recipients' e-mail address; a full recipients' mailbox; a recipients' server error; and a blocked IP-address

In some implementations of the server, the modified electronic message further comprises a second interface element associated with at least one other action.

In some implementations of the server, the at least one other action is deleting the modified electronic message.

In some implementations of the server, the modified electronic message causes the electronic device to display a content representation of the modified electronic message to the user, the modified electronic message includes the first interface element.

In some implementations of the server, the modified electronic message causes the electronic device to display the first interface element in an inbox view, the inbox view displays at least one indication of the modified electronic message which is visually distinguishable from the at least one other electronic message.

In some implementations of the server, the first interface element is for allowing the user to execute the remedial action directly from the inbox view without opening the modified electronic message.

In some implementations of the server, the server is further configured to determine that the electronic message is a bounce message.

In some implementations of the server, to generate the modified electronic message, the server generates commands for displaying at least the first interface element.

In the context of the present specification, unless expressly provided otherwise, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, unless expressly provided otherwise, “client device” is any computer hardware that is capable of running software appropriate to the relevant task at hand. Thus, some (non-limiting) examples of client devices include personal computers (desktops, laptops, netbooks, etc.), smartphones, and tablets. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, unless expressly provided otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, unless expressly provided otherwise, the expression “component” is meant to include software (appropriate to a particular hardware context) that is both necessary and sufficient to achieve the specific function(s) being referenced.

In the context of the present specification, unless expressly provided otherwise, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, unless expressly provided otherwise, the expression “interactive” is meant to indicate that something is responsive to a user's input or that at least portions thereof are responsive to a user's input.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a file could include the file itself (i.e. its contents), or it could be a unique file descriptor identifying the file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication. Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic illustration of a computer system being an implementation of the present technology;

FIG. 2 illustrates an example of an original electronic message sent by the user;

FIG. 3 illustrates an example of a bounced electronic message sent by the web mail server;

FIG. 4 illustrates an example of a content representation of the modified electronic message;

FIG. 5 illustrates a method for generating the modified electronic message;

FIG. 6 illustrates an exemplary user's inbox view with the visually distinguishable content representation of the modified electronic message;

FIG. 7A-7C illustrates different embodiments of the present technology in the context of a first scenario;

FIG. 8A-8C illustrates different embodiments of the present technology in the context of a second scenario;

FIG. 9A-9D illustrates different embodiments of the present technology in the context of a third scenario;

FIG. 10 illustrates an example of a table stored for implementing some embodiments of the present technology

### DESCRIPTION

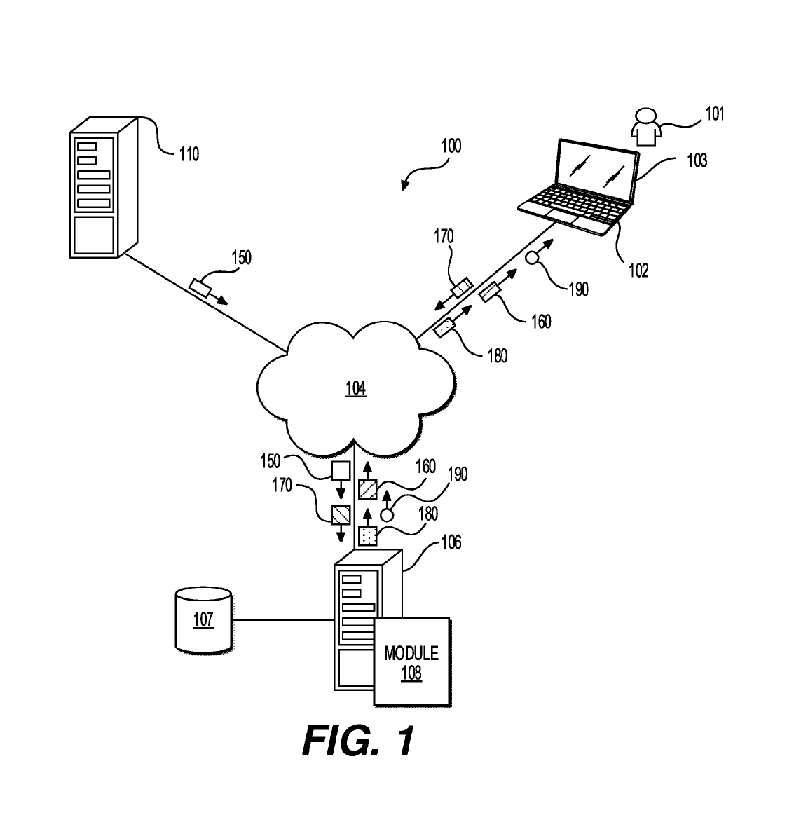

Referring to FIG. 1, there is shown a diagram of a system 100, the system 100 being suitable for implementing non-limiting embodiments of the present technology. It is to be expressly understood that the system 100 is depicted merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The system 100 comprises an electronic device 102. The electronic device 102 is typically associated with a user 101 and, as such, can sometimes be referred to as a “client device”. It should be noted that the fact that the electronic device 102 is associated with the user 101 does not need to suggest or imply any mode of operation—such as a need to log in, a need to be registered or the like.

The implementation of the electronic device 102 is not particularly limited, but as an example, the electronic device 102 may be implemented as a personal computer (desktops, laptops, netbooks, etc.), a wireless electronic device (a cell phone, a smartphone, a tablet and the like), as well as network equipment (a router, a switch, or a gateway). Merely for the purposes of an illustration, it shall be assumed that the electronic device 102 is implemented as a laptop computer, such as LENOVO™ THINKPAD™ X220 lap top running a WINDOWS™ operating system.

The electronic device 102 comprises hardware and/or software and/or firmware (or a combination thereof) to execute a browser 103. Generally speaking, the purpose of the browser 103 is to enable the user 101 to access one or more networked resources over a communication network 104, including a mail service available on a server 106, which server 106 is also coupled to the communication network 104.

How the browser 103 is implemented is not particularly limited. One example of the browser 103 may be a YANDEX™ browser. Alternatively, the browser 103 can be implemented as a GOOGLE CHROME™ browser, an OPERA™ browser, and the like.

Using the browser 103, the user 101 of the electronic device 102 is able to access the mail service provided by the server 106 by typing in a Universal Resource Locator (URL) of a web portal or a web page that hosts the mail service, such as mail.yandex.ru, gmail.com or the like. Naturally, the user 101 can also click a link from a document, select a bookmark, select a favourite website link and the like to access the mail service. How the user 101 accesses, signs up for, logs in and logs out of the mail service is generally known in the art and, as such, will not be described here at any length.

Additionally, even though the description to be presented herein below will use the example of the browser 103 being used for accessing the mail service, teachings presented herein should not be construed as so limited. In other embodiments of the present technology, the electronic device 102 can execute another application (such as an e-mail application or a messaging application) and teachings presented herein can be equally applied to such other applications executed by the electronic device 102. Naturally, the other type of the messaging service can also be accessed using the browser 103 or a dedicated application.

In some non-limiting embodiments of the present technology, the communication network 104 can be implemented as the Internet. In other embodiments of the present technology, the communication network 104 can be implemented differently, such as any wide-area communication network, local-area communication network, a private communication network and the like. The electronic device 102 is coupled to the communication network 104.

Recalling that the electronic device 102 can be implemented, in this example, as a laptop, the communication link with the communication network 104 can be wireless (such as the Wireless Fidelity, or WiFi® for short, Bluetooth® or the like) or wired (such as Ethernet based connection). In other embodiments, the communication link with the communication network 104 can be wireless—such as the Wireless Fidelity, or WiFi® for short, Bluetooth® or the like or cellular (such as 3G, LTE and the like).

It should be expressly understood that implementations for the electronic device 102 and the communication network 104 are provided for illustration purposes only. As such, those skilled in the art will easily appreciate other specific implementational details for the electronic device 102 and the communication network 104. As such, by no means, examples provided herein above are meant to limit the scope of the present technology.

The server 106 can be implemented as a conventional computer server. In an example of an embodiment of the present technology, the server 106 can be implemented as a Dell™ PowerEdge™ Server running the Microsoft™ Windows Server™ operating system. Needless to say, the server 106 can be implemented in any other suitable hardware and/or software and/or firmware or a combination thereof. In the depicted non-limiting embodiment of present technology, the server 106 is a single server. In alternative non-limiting embodiments of the present technology, the functionality of the server 106 may be distributed and may be implemented via multiple servers.

The server 106 comprises hardware and/or software and/or firmware (or a combination thereof) to execute a mail service, as is generally known in the art. As has been described above, the mail service of the server 106 can be accessed using the browser 103 or a dedicated e-mail client. In other embodiments, the server 106 is configured to execute another type of a messaging application, such as, an instant messaging application, a short messaging application and the like. Examples of such applications include but are not limited to: SKYPE™ instant messaging application, WHATS APP™ messaging application and the like.

The server 106 comprises or has access to a data storage 107, which data storage 107 is used by the server 106 to store incoming and outgoing messages for the subscribers of the mail service hosted by the server 106. The server 106 can use the data storage 107 to host subscribers' profiles, log in information, billing information and the like. The term “subscriber” should not be interpreted to have any particular meaning and, as such, teachings of the present technology equally apply to both “free” and “paid for” messaging services.

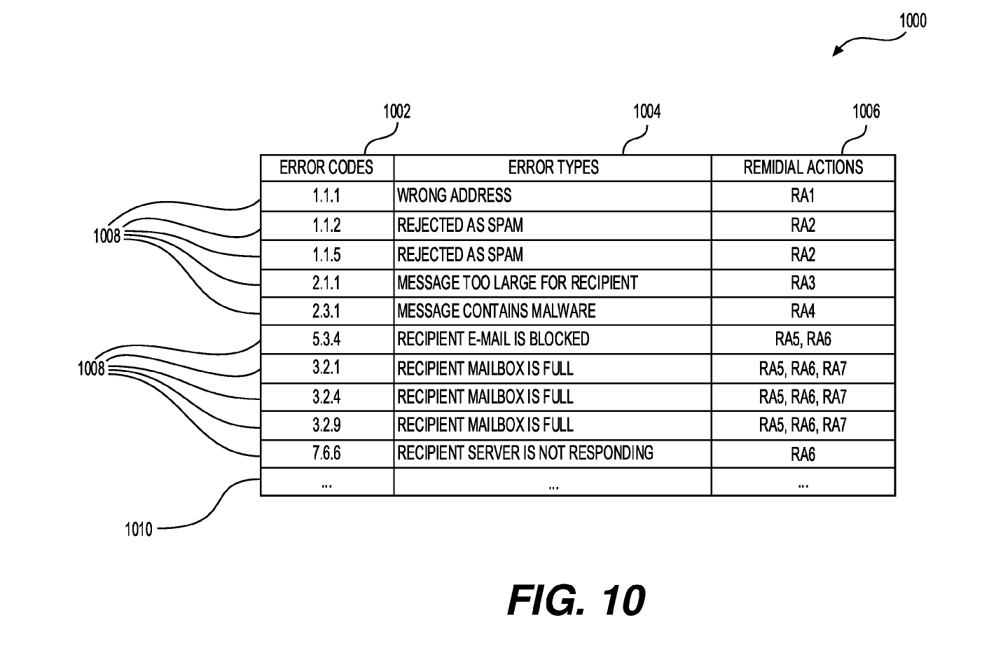

The data storage 107 may store a table 1000 depicted in FIG. 10. How the table is implemented is not a limiting aspect of the present technology. However in some embodiments, the table 1000 may comprise three columns, namely an “error code” column 1002, an “error type” column 1004 and a “remedial actions” column 1006. Each row 1008 within the column corresponds to an error code. It should be noted that different error codes may correspond to the same error type. For example, error codes 1.1.2 and 1.1.5 can correspond to the error type “Rejected as spam”. Moreover, different remedial actions may be associated with the same error type. For example, remedial actions “RA5”, “RA6” and “RA7” may be associated with the error type “Recipient mailbox is full”. Also, a remedial action may correspond to different error types. For example, “RA6” corresponds to error types “Recipient e-mail is blocked”, “Recipient mailbox is full” and “Recipient server is not responding”. It should be noted that different combinations of error codes, error types and remedial actions are possible. The combinations illustrated in FIG. 10 are depicted for explanation purposes only.

Row 1010 indicates that any number of additional rows may be included within the table 1000 and that it is not limited to the depicted number of rows 1008. Furthermore, FIG. 10 does not illustrate the only error codes, error types and remedial actions possible and, therefore, any additional number of error codes, error types and remedial actions may be contemplated within the scope of the present technology.

Returning to FIG. 1, the server 106 also comprises or has access to a module 108, which module 108 is used by the server 106 to execute at least some functionalities of the present technology which will be further discussed below. It is to be noted that the implementation of the module 108 is not a limiting aspect of the present technology and is not intended to be. A person skilled in the art would understand that other modifications to the system 100 are possible for executing the functionalities of the module 108.

Similarly to the server 106, a mail server 110 is connected to the communication network 104. The mail server 110 can be implemented as a conventional computer server. In an example of an embodiment of the present technology, the mail server 110 can be implemented as a Dell™ PowerEdge™ Server running the Microsoft™ Windows Server™ operating system. Needless to say, the mail server 110 can be implemented in any other suitable hardware and/or software and/or firmware or a combination thereof. In the depicted non-limiting embodiment of present technology, the mail server 110 is a single server. In alternative non-limiting embodiments of the present technology, the functionality of the mail server 110 may be distributed and may be implemented via multiple servers. The mail server 110 comprises hardware and/or software and/or firmware (or a combination thereof) to execute a mail service, as is generally known in the art. In an embodiment of the present technology, user 101 may send an e-mail to an e-mail address associated with the web mail service executed by the mail server 110. In some embodiments, the server 106 and the mail server 110 may be implemented as a single server.

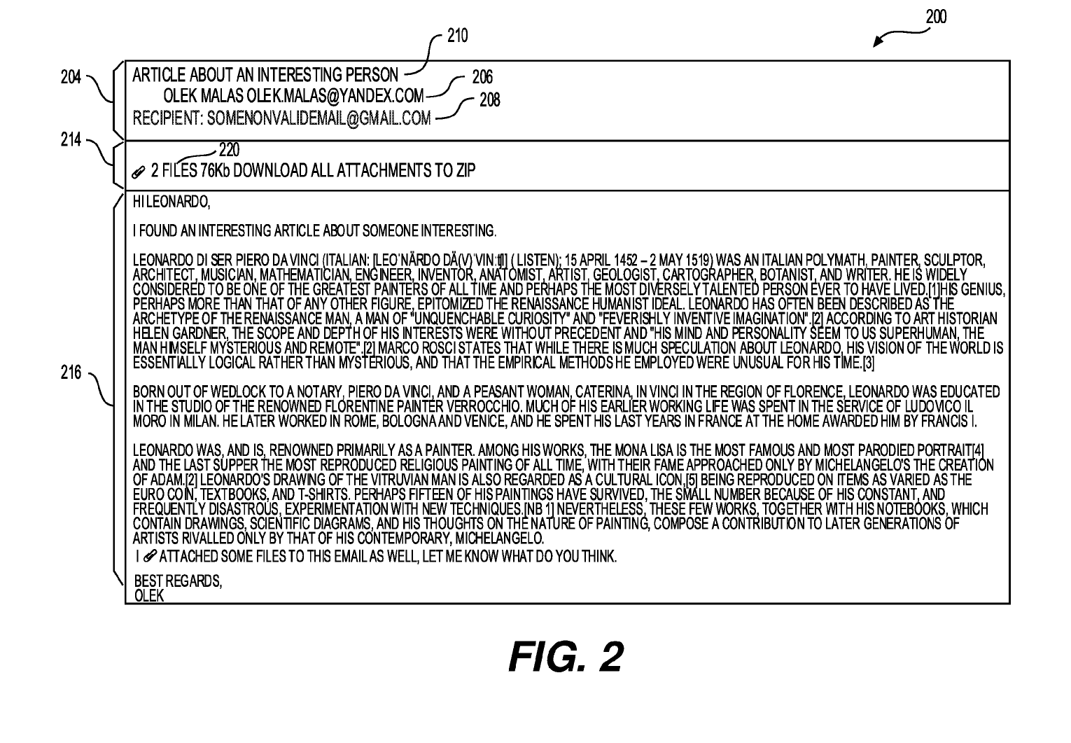

In an embodiment of the present technology, the user 101 has previously sent (not depicted) an original message to an e-mail address associated to a mail service executed at the mail server 110. As an illustration, the original message sent by the user 101 is depicted in FIG. 2. The content of an original message 200 may comprise a header field 204 which comprises the user's e-mail address 206, one or more recipients' e-mail addresses 208 and an email subject/title 210. The header field 204 may comprise additional elements and fields which are not depicted in FIG. 2. The content of the original message 200 further comprises an attachment toolbar 214 with attachments 220 and a message body 216. The content of the original message 200 may be stored by the server 106, which executes the web mail service associated with the user's email address 206, in the data storage 107.

The original message 200 may comprise further options, functionalities and/or elements (e.g., print, time, flag, attachments, etc.) pertaining to e-mail messages that are known in the art. It is to be noted that these options, functionalities and/or elements were not depicted in FIG. 2 for the sake of simplicity. Therefore, the e-mail message elements in FIG. 2 are depicted for illustration purposes only and should not be considered as limiting aspects of the present technology.

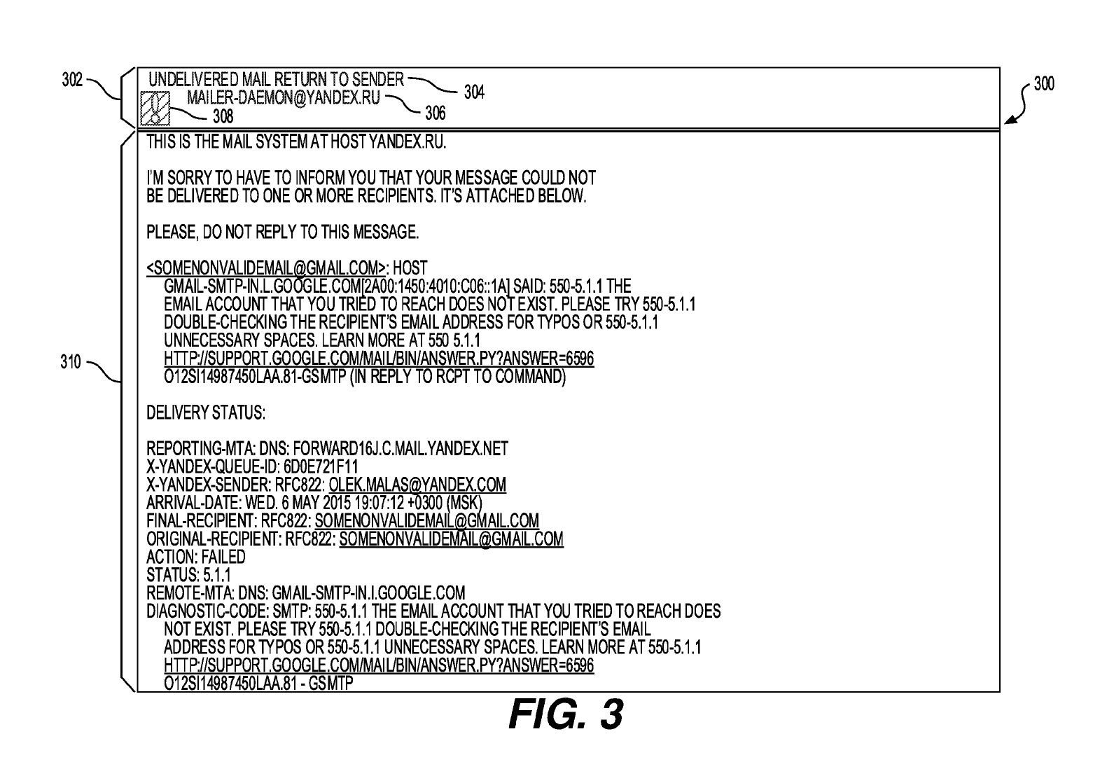

Let's assume that some error occurred and that the original message 200 could not be delivered to one or more recipients' addresses 208 that are associated to the mail service executed at the mail server 110, indicated by the user 101 in the original message 200. One or more recipients' addresses 208 may be associated with different mail services. Failure to deliver the original message 200 will trigger the generation of an automatic e-mail message by the mail server 110 to notify the user 101 of the delivery problem. In this example, the original message 200 is said to have bounced. In an embodiment of the present technology, the automatic e-mail message generated by the mail server 110 may be a bounce message 300 depicted in FIG. 3. The content of the bounce message 300 may comprise a header field 302 and a message body 310. The header field 302 may comprise a subject/title 304, a sender address 306 and an icon 308 associated with a non-delivery error. As it can be seen in FIG. 3, the header field 302 may comprise a first content portion (not separately numbered) of the bounce message 300. Also, the message body 310 may comprise a second content portion of the bounce message 300. Both the first and the second content portions are unintelligible to the user 101 in regard to an indication of an error type that caused the bounce message 300 to have been generated. In fact, presenting such information to the user 101 is not very helpful due to its incomprehensive nature for a common user. It is to be noted that the bounce message 300 may comprise additional options, functionalities and/or elements (e.g., print, time, flag, attachments, etc.) associated to bounce messages as a person skilled in the art would understand. These additional options, functionalities and/or elements are not depicted in FIG. 3 for the sake of simplicity.

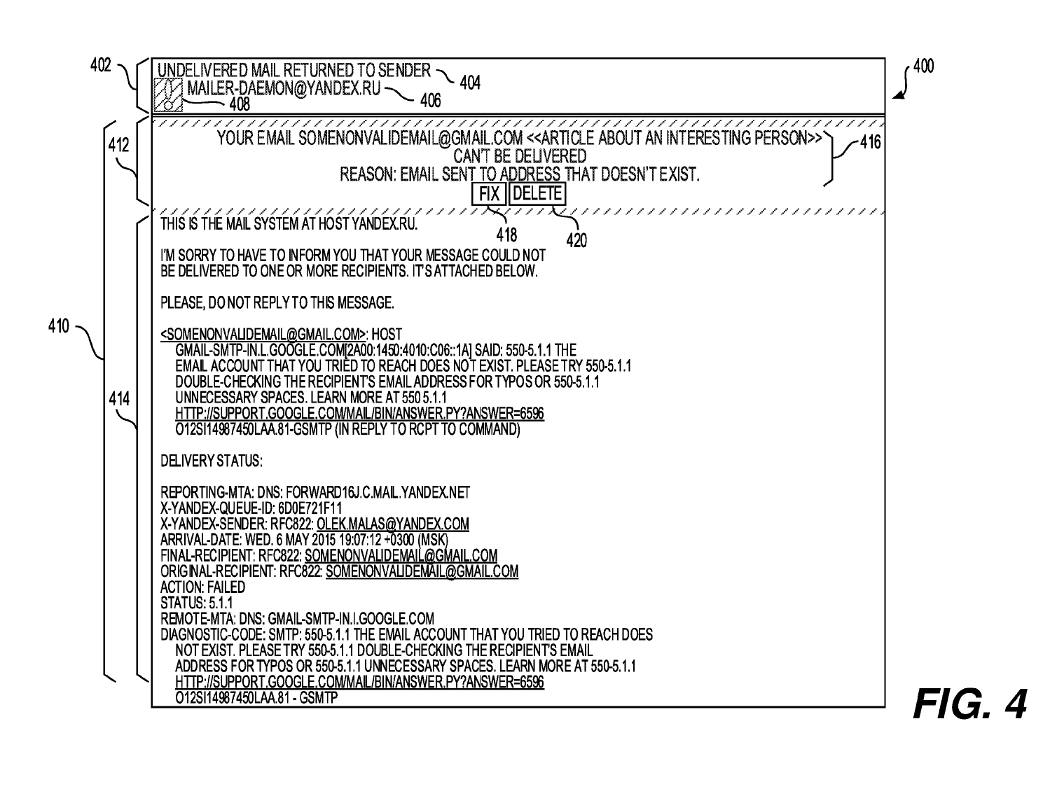

In an embodiment of the present technology, the mail server 110 depicted in FIG. 1 may send a data packet 150 comprising the bounce message 300 via the communication network 104 to the server 106 since the original message 200 was previously transmitted thereto by the mail service executed at the server 106 to which the e-mail address of user 101 is associated. The server 106 may be configured to execute a method 500, which will be described in details below, for generating a content representation 400 of a modified electronic message depicted in FIG. 4. The content representation 400 of the modified electronic message may comprise a header 402 with a subject/title 404, the sender address 406 and an icon 408 associated with a non-delivery error. In some embodiments, the header 402 may comprise at least a portion of the first content portion of the bounce message 300 that is unintelligible to user 101 in regard to an indication of an error type that caused the bounce message 300 to have been generated. In other embodiments, the header 402 may omit the first content portion of the bounce message 300.

The content representation 400 of the modified electronic message has a message body 410 which may comprise a first section 414 and a second section 412. In some embodiments, the first section 414 may comprise at least a portion of the second content portion of the bounce message 300 that is unintelligible to user 101 in regard to an indication of an error type that caused the bounce message 300 to have been generated. In other embodiments, the first section 414 may be omitted so that the message body 410 comprises only the second section 412. Further, the second section 412 comprises information intelligible to user 101 corresponding to the error type that caused the original message 200 to bounce and associated with at least one remedial action that user 101 may wish to select. In other words, the second section 412 may comprise an indication 416 of the error type, a first interface element 418 for displaying to the user 101 an indication of at least one remedial action and a second interface element 420 associated with at least one other action. For example, the one other action may be deleting the modified electronic message. In some embodiments, the indication 416 of the error type is an informational snippet and the interface elements 418 and 420 are buttons—all of which were generated following the execution of method 500 by the server 106. The user may actuate the second interface element 420 for executing an action associated therewith. In some embodiments, the user 101 may actuate the first interface element 418 for displaying at least one additional indication of the at least one remedial action. In other embodiments, the user 101 may actuate the first interface element 418 for sending to the server 106 an indication 170 depicted in FIG. 1 of the first interface element 418 being actuated. In alternative embodiments, the user 101 may actuate the first interface element 418 for executing the at least one remedial action. In additional embodiments, more than one first interface elements 418 may be generated following the execution of method 500.

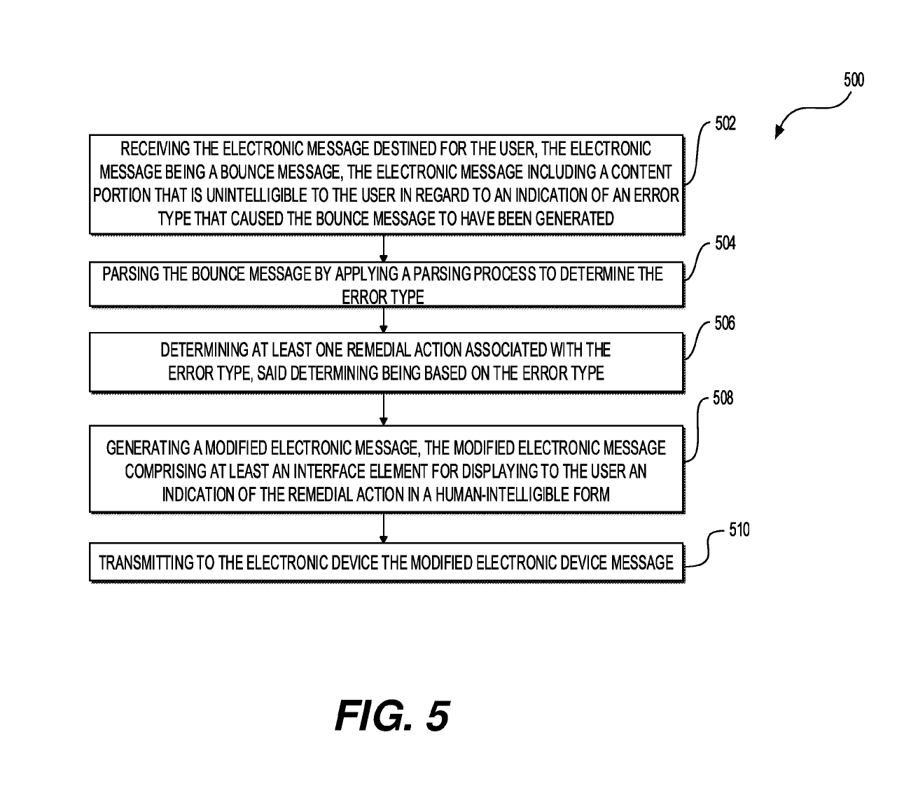

The method 500 will now be described in further detail with reference to FIG. 5.

STEP 502: Receiving the Electronic Message Destined for the User, the Electronic Message being a Bounce Message, the Electronic Message Including a Content Portion that is Unintelligible to the User in Regard to an Indication of an Error Type that Caused the Bounce Message to have been Generated

In some embodiments, the server 106 receives, from the mail server 110, via the communication network 104, the data packet 150 associated with the bounce message 300 being unintelligible to the user 101 in regard to an indication of an error type that caused the bounce message to have been generated. It is to be noted that the server 106 may store the data packet 150 in the data storage 107.

STEP 504: Parsing the Bounce Message by Applying a Parsing Process to Determine the Error Type

In some embodiments, the module 108 may parse the data packet 150 to extract error data associated with the bounce message 300. A parser is a software component that takes input data and builds a data structure which is often a parse tree, an abstract syntax tree or other hierarchical structure. Parsing the input data provides a structural representation of the input and checks for correct syntax in the process. Data packet 150 may be parsed with various parsing algorithms for parsing natural language such as generalized left-to-right rightmost derivation parser algorithm (GLR-parser) and with its derivatives (e.g., left-to-right leftmost derivation parsers (LL-parsers), recursive-descent parser and the like). The parser may also use regular expressions, databases and repositories for specific types of data and various machine learning algorithms Other parsing algorithms and parsing processes may be implemented within some embodiments of the present technology. In other embodiments, parsing data packet 150 may comprise applying at least one mask to the data packet 150. It should be noted that the method 500 is not limited to a particular parser and\or a specific parsing technique.

After the error data associated with the bounce message 300 is extracted from the data packet 150, the module 108 within the server 106 may analyse the error data to determine an error type of the bounce message 300. In some embodiments, the determination of the error type of the bounce message 300 may be achieved by mapping error codes, contained within the error data extracted from the data packet 150, using the table 1000. As mentioned supra, the table 1000 may have been previously constructed and stored within the data storage 107. It should be recalled, multiple error codes within the error data extracted from data packet 150 may be associated to one error type. For example, error codes 1.1.2 and 1.1.5 may be associated with one error type and error codes 3.2.X (where X may be any given number within a variety of numbers) may be associated to another error type.

In an embodiment of the present technology, the method 500 may attribute at least one error type from a variety of error types to the bounce message 300. For example, the error type determined by the module 108 within the server 106 may be a wrong destination address, a rejection as spam, an original electronic message exceeding allowed size for a recipient, an original electronic message containing malware, a blocked recipients' e-mail address, a full recipients' mailbox, a recipients' server error, a blocked IP-address, and the like. In other embodiments, additional error types may be determined in response to the data packet 150 being parsed and analysed by the module 108 within the server 106.

STEP 506: Determining at Least One Remedial Action Associated with the Error Type, Said Determining being Based on the Error Type

In some embodiments, when the error type of the bounce message 300 is determined, the method 500 may further determine at least one remedial action associated with the error type. For example, the determination of at least one remedial action may be performed by identifying the at least one remedial action associated to the error type, the error type having been determined in step 504, within the table 1000. As has been alluded to above, multiple error types may correspond to one remedial action and multiple remedial actions may correspond to one error type.

In other embodiments of the present technology, a relational database between error codes, error types and remedial actions may have been populated and stored within the data storage 107. In such implementations, an “error code” table and an “error type” table may have a one-to-one relationship. Moreover, a many-to-many relationship may be established between the “error type” table and a “remedial action” table. It should be noted that determining at least one remedial action in conjunction with the at least one error type may be executed in different manners form those described as examples herein.

STEP 508: Generating a Modified Electronic Message, the Modified Electronic Message Comprising at Least an Interface Element for Displaying to the User an Indication of the Remedial Action Intelligible to the User

Data packet 160 may be configured to cause the electronic device 102 to display to user 101 on the display (not depicted) of the electronic device 102 the content representation 400 of the modified electronic message and at least the interface element depicted in FIG. 4. In some embodiments, at step 508 the module 108 within the server 106 generates a data packet 160 depicted in FIG. 1. Data packet 160 comprises data associated with the modified electronic message. The modified electronic message may or may not comprise at least a portion of the first content portion of the bounce message 300. Also, the modified electronic message may or may not comprise at least a portion of the second content portion of the bounce message 300.

The modified electronic message within the data packet 160 may further comprise commands for generating information intelligible to user 101 corresponding to the error type that caused the original message 200 to bounce and associated with at least one remedial action that user 101 may wish to select. In some embodiments, the commands may therefore generate the indication 416 of the error type, the first interface element 418 for displaying to the user 101 the indication of at least one remedial action and the second interface element 420 associated with at least one other action. In other embodiments, the commands may further generate the at least one additional indication of the at least one remedial action. In alternative embodiments, the commands may generate more than one of first interface elements 418, each first interface element 418 being associated with different remedial actions determined in step 506, respectively. Additional commands may be included in the modified electronic message within data packet 160 for implementing some embodiments of the present technology as will be described below.

The modified electronic message within data packet 160 may further comprise commands for executing different actions that the user 101 may select in respect of the content representation 400 of the modified electronic message. In some embodiments, data packet 160 may comprise commands for executing the action associated with the second interface element upon the actuation thereof by the user 101. In other embodiments, the modified electronic message within data packet 160 may comprise commands for displaying the at least one additional indication of the at least one remedial action upon the actuation of the first interface element 418 by the user 101.

In alternative embodiments, the modified electronic message within data packet 160 may comprise commands for sending to the server 106 an indication 170 depicted in FIG. 1 of the first interface element 418 being actuated upon the actuation thereof by the user 101. In another embodiment, the modified electronic message within data packet 160 may comprise commands for executing the at least one remedial action associated with the first interface element 418 upon the actuation thereof by the user 101. Additional commands may be included in the modified electronic message within data packet 160 for implementing various embodiments of the present technology as will be described below.

STEP 510: Transmitting to the Electronic Device the Modified Electronic Message

In some embodiments, the server 106 may transmit, to the electronic device 102, via the communication network 104, the data packet 160 comprising data associated with the modified electronic message and being further configured to cause the electronic device 102 to display to user 101 on the display of the electronic device 102 the content representation 400 of the modified electronic message. It is to be noted that the server 106 may store the data packet 160 in the data storage 107 prior to transmitting the data packet 160 to the electronic device 102. The modified electronic message within data packet 160 may comprise commands for generating information intelligible to the user 101 corresponding to the error type associated with an error that caused the original message 200 to bounce and associated with at least one remedial action that user 101 may wish to select. Further, the modified electronic message within data packet 160 may further comprise commands for executing different actions selected by the user 101 in respect with the displayed content representation 400 of the modified electronic message.

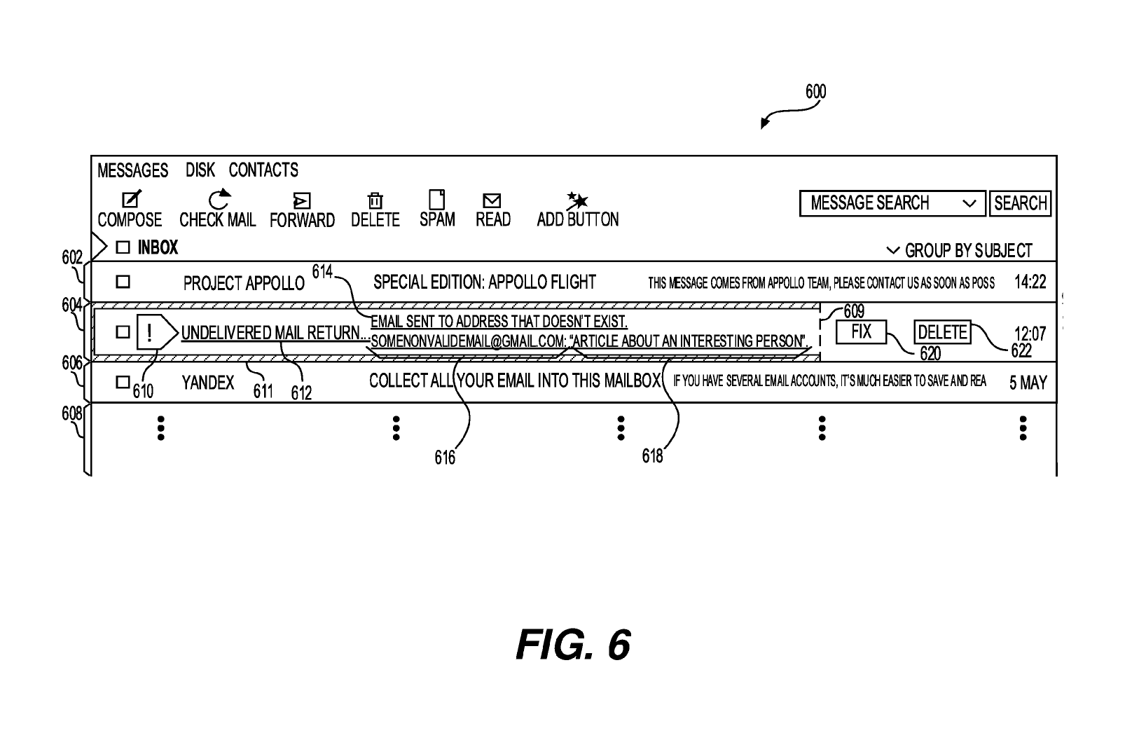

After the server 106 executes the method 500, the user 101 may execute on the electronic device 102 the browser 103 to access the mail service on the server 106. In another embodiment, user 101 already has access to the mail service on the server 106 and may refresh the browser 103. The display of the electronic device 102 may display to the user 101 an inbox view 600 of the mail service which is depicted in FIG. 6. The inbox view 600 comprises a content representation 604 of a modified electronic message and other electronic messages 602 and 606.

It should be noted that many electronic messages 608 may be shown concurrently with the content representation 604 of the modified electronic message. In an embodiment, the content representation 604 of the modified electronic message is visually distinguishable from at least one other electronic message that is not a bounce message in the inbox view 600 of the mail service. The content representation 604 of the modified electronic message in the inbox view 600 comprises visually distinguishable graphical elements 609, 610 and 611—all of which were generated by additional commands included in the modified electronic message within data packet 160. In other embodiments, the content representation 604 of the modified electronic message may further comprise a subject\title 612 of the modified electronic message, an indication 614 of the error type that caused the original message sent by user 101 to bounce, a recipient's e-mail address 616 and a subject\title 618 of the original message sent by user 101. Also, the content representation 604 of the modified electronic message comprises a first interface element 620 for displaying to the user 101 the indication of the at least one remedial action and a second interface element 622 associated with at least one other action. For example, the at least one other action associated to the second interface element 622 may correspond to the deletion of the modified electronic message by the user 101 if she desires to do so by actuating the second interface element 622.

In some embodiments, more than one first element 620 may be displayed within the content representation 604 of the modified electronic message in the inbox view 600. In another embodiment, fewer or more visually disguisable graphical elements may be displayed in the inbox view 600 for visually distinguishing the content representation 604 of the modified electronic message from other electronic messages. In alternatives embodiments, the first interface element 620 and the second interface element 622 may be omitted from the content representation 604 of the modified electronic message in the inbox view 600. It is to be noted that the inbox view 600 may comprise additional options, functionalities and/or elements associated to electronic messages and to the mail service as a person skilled in the art would understand. These additional options, functionalities and/or elements are not depicted in FIG. 6 for the sake of simplicity.

In some embodiments, upon the user 101 actuating the first interface element 620, the indication 170 depicted in FIG. 1 of user 101 actuating the first interface element 620 is sent from the electronic device 102, via the communication network 104, to the server 106 following the execution of a command comprised in the modified electronic message within data packet 160 previously received from the server 106. Responsive to the indication 170, the server 106 may execute the remedial action associated with the first interface element 620 and transmit, to the electronic device 102, via the communication network 104, a confirmation 180 of the action having been executed. In other embodiments, the confirmation 180 of the action having been executed may be omitted.

In further embodiments, responsive to the indication 170 of user 101 actuating the interface element 620, the server 106 may transmit a trigger 190 to the electronic device 102, via the communication network 104, comprising commands for generating and displaying an indication of the error type and commands for executing different actions that the user 101 may select. In alternative embodiments, commands for generating the indication of the error type and commands or executing different actions that the user 101 may select can be contained in the modified electronic message and may have been already transmitted by the server 106 within the data packet 160 as mentioned above.

Different scenarios following the actuation of the interface element 620 will now be described.

Scenario 1: Recipient's Address does not Exist

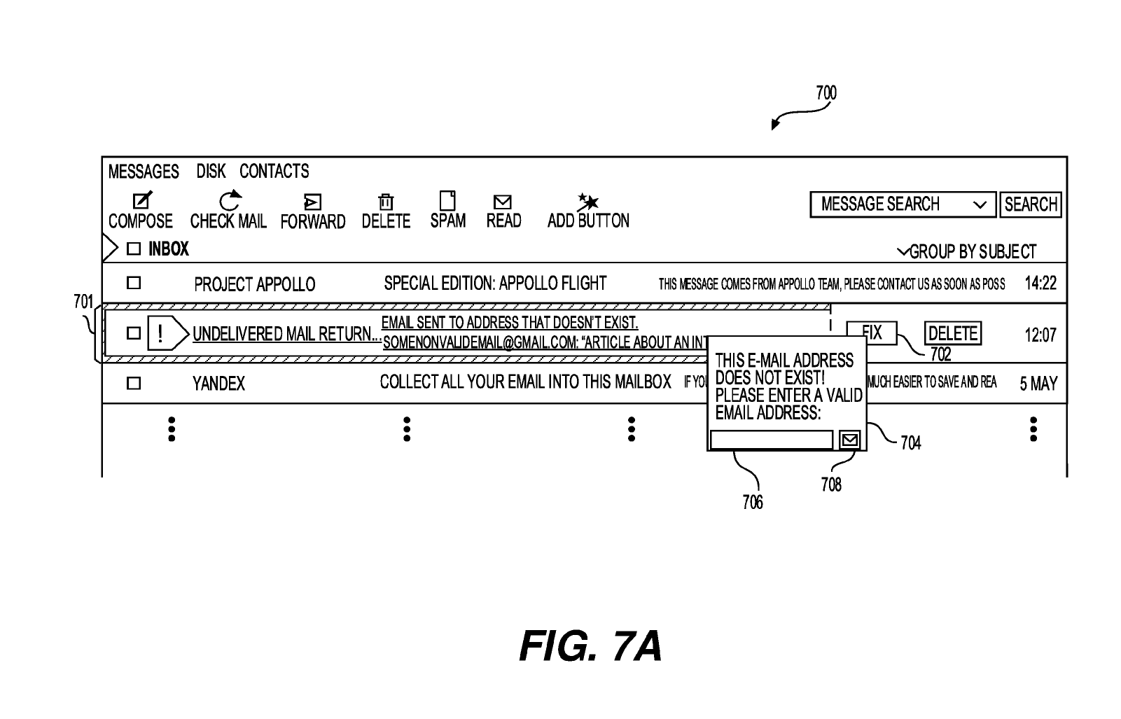

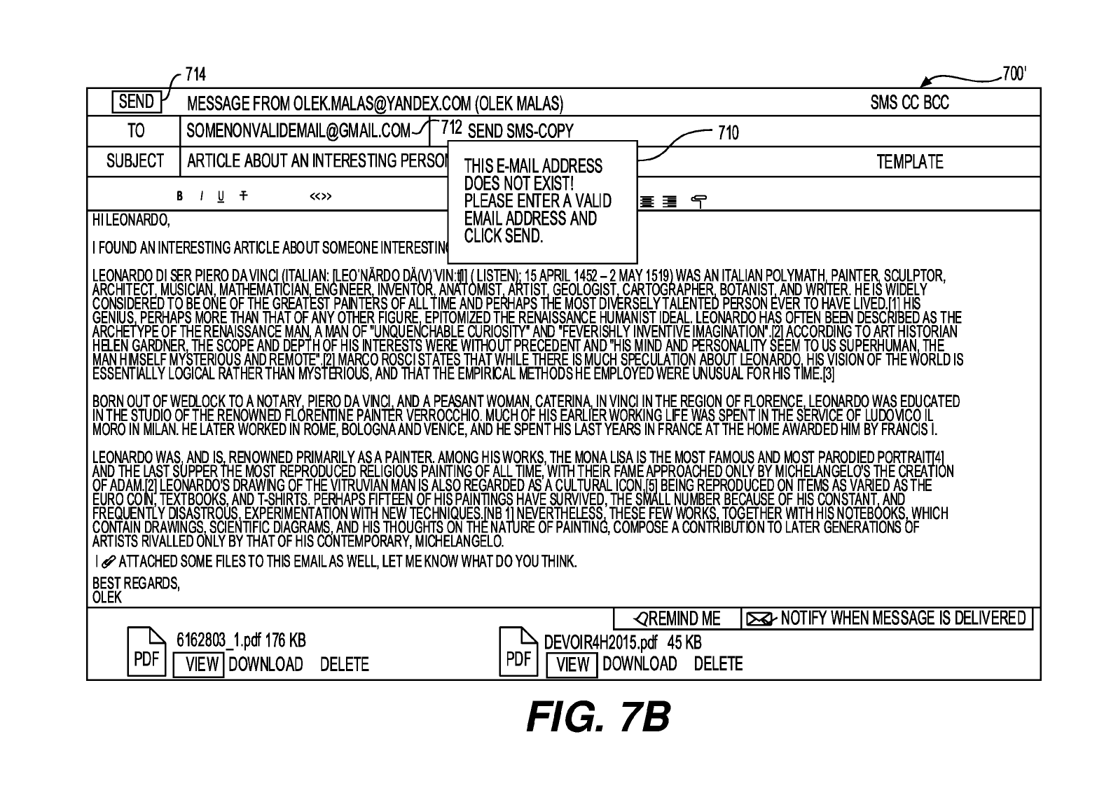

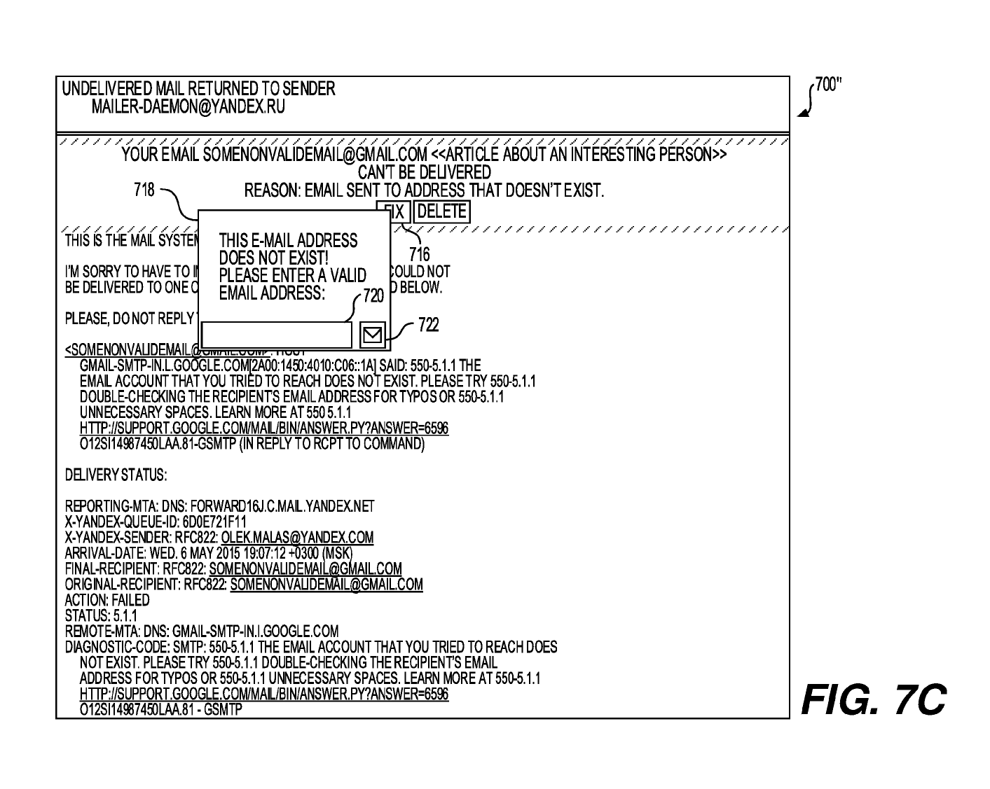

For this example, let's say that the original message bounced because the recipient's address indicated by user 101 does not exist. The method 500 is executed by the server 106. User 101 is presented with a content representation 701 of the modified electronic message in an inbox view 700, the inbox view 700 being depicted in FIG. 7A, of the mail service executed by server 106, which is displayed in the browser 103 on the electronic device 102. User 101 may actuate a first interface element 702 for displaying at least one additional indication of a remedial action within the inbox view 700. In some embodiments, the commands for generating the at least one additional indication of the remedial action associated with the first interface element 702 and commands for executing different actions that the user 101 may select following the display of the at least one additional indication of the remedial action are comprised in the modified electronic message and already have been transmitted within data packet 160 to the electronic device 102. In this case, a floating graphical element 704 is generated and displayed directly following the actuation of the first interface element 702 upon the execution of the command to do so responsive to the actuation of the first interface element 702.

In further embodiments, the indication 170 of the user 101 actuating the interface element 702 is sent by the electronic device 102, via the communication network 104, to the server 106. Responsive to the indication 170, the server 106 may transmit the trigger 190 comprising commands for generating and displaying the indication of the error type and commands for executing different actions that the user 101 may select following the display of the at least one additional indication of the remedial action.

As a result, the floating graphical element 704 is generated and displayed within the inbox view 700. The floating graphical element 704 may appear on the right, on the left, over, under or in any position that is in proximity with the content representation 701 of the modified electronic message and\or the first interface element 702 within the inbox view 700. The floating graphical element 704 may also appear in any other position within the inbox view 700. The floating graphical element 704 may comprise an informational snippet for indicating to user 101 that she may enter a valid recipient's address in the address box 706. A send button 708 may also be present within the floating graphical element 704 so that user 101 may re-send the original message that bounced to the valid recipient's address entered in the address box 706.

In another embodiment, upon actuation of the first interface element 702 by the user 101, the server 106 may send the trigger 190 comprising commands for displaying the original electronic message 700′ (depicted in FIG. 7B) that caused the bounced message, the original electronic message 700′ being displayed in a user-editable form, and commands for executing different actions that the user 101 may select following the display of the original electronic message 700′. Additionally, trigger 190 may comprise further commands for generating and displaying a floating graphical element 710, the floating graphical element 710 being displayed in any position that is in proximity with the invalid recipient's address 712 indicated in the original electronic message 700′. The floating graphical element 710 may also be generated and displayed in any other position within the original electronic message 700′. The floating graphical element 710 may comprise an informational snippet for indicating to user 101 what can be done for remediating the non-delivery of the original electronic message 700′. In this example, user 101 is indicated to enter a valid recipient's address and click on the send button 714. In other embodiments, the commands comprised in the trigger 190 may generate and display the informational snippet within the message body of the original electronic message 700′ instead of generating the floating graphical element 710.

It should be noted that the floating graphical element 710 may be rather embedded within the message body of the original electronic message 700′ as opposed to floating over at least some content of the original electronic message 700′. In alternative embodiments, the at least one additional indication of the remedial action generated and displayed by the commands comprised within the trigger 190 may be the original electronic message 700′ in a user-editable form with the cursor of the electronic device 102 pointing at the invalid recipient's address 712. In yet other embodiments, the commands for generating the at least one indication of the remedial action associated with the first interface element 702 and commands for executing different actions that the user 101 may select following the display of the at least one additional indication of the remedial action are comprised in the modified electronic message and already have been transmitted within data packet 160 to the electronic device 102. In this case, the original electronic message 700′ and the floating graphical element 710 (or embedded) are displayed directly following the actuation of the first interface element 702, upon the execution of the command to do so responsive to the actuation of the first interface element 702, without the need of sending the indication 170 and receiving the trigger 190 from server 106.

Moreover, the user 101 may select to click on the content representation 701 of the modified electronic message in the inbox view 700 instead of actuating the first interface element 702. In this case, commands within the data packet 160 may generate the content representation 700″ of the modified electronic message depicted in FIG. 7C and the user 101 will be presented therewith on the electronic device 102. Upon actuation a first interface element 716, the indication 170 of the user 101 actuating the first interface element 716 is sent to the server 106. Responsive to the indication 170, the server 106 may transmit the trigger 190 comprising commands for generating and displaying at least one additional indication of a remedial action associated with the first interface element 716 and commands for executing different actions that the user 101 may select following the display of the at least one additional indication of the remedial action.

As a result, a floating graphical element 718 is generated and displayed within the content representation 700″ of the modified electronic message. The floating graphical element 718 may appear on the right, on the left, over, under or in any position that is in proximity with the first interface element 716 within the content representation 700″ of the modified electronic message. Also, the floating graphical element 718 may be displayed in any other position within the content representation 700″ of the modified electronic message. The floating graphical element 718 may comprise an informational snippet for indicating to user 101 that she may enter a valid recipient's address in an address box 720. A send button 722 may also be displayed within the floating graphical element 718 so that user 101 may re-send the original message that bounced to the valid recipient's address entered in the address box 720.

In further embodiments, the commands for generating the at least one indication of the remedial action associated with the first interface element 716 and commands for executing different actions that the user 101 may select following the display of the at least one additional indication of the remedial action are comprised in the modified electronic message and already have been transmitted within data packet 160 to the electronic device 102. In this case, the floating graphical element 718 is generated and displayed directly following the actuation of the first interface element 716, upon the execution of the command to do so responsive to the actuation of the first interface element 716, without the need of sending the indication 170 and receiving the trigger 190 from server 106.

### Scenario 2: Considered as Spam

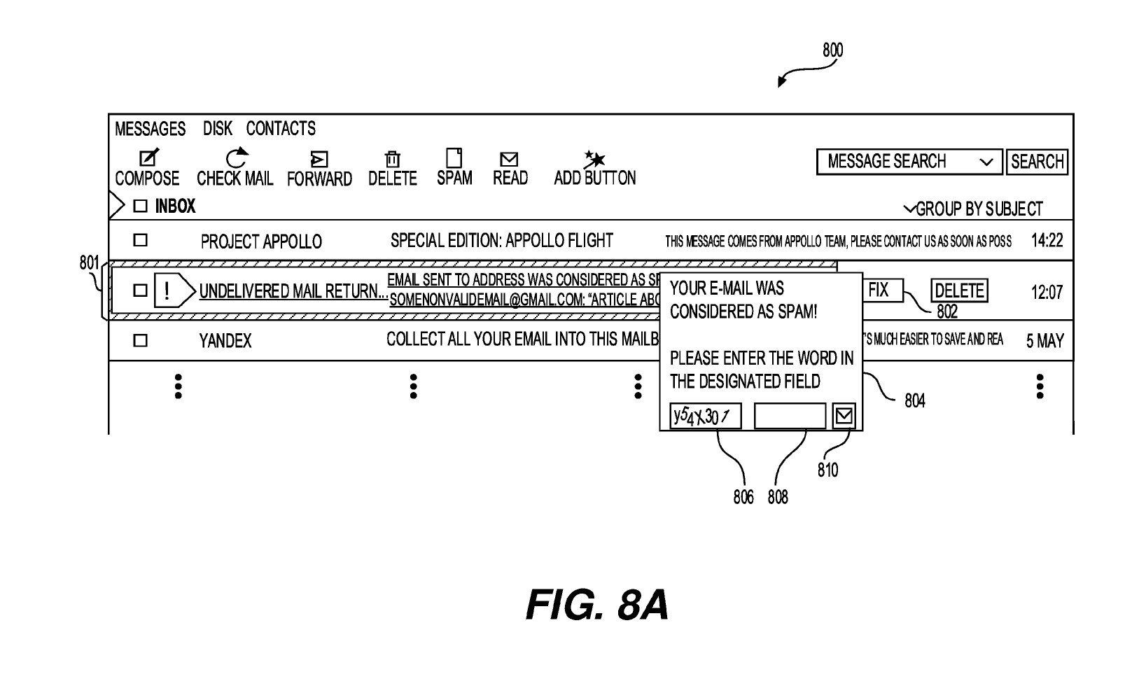

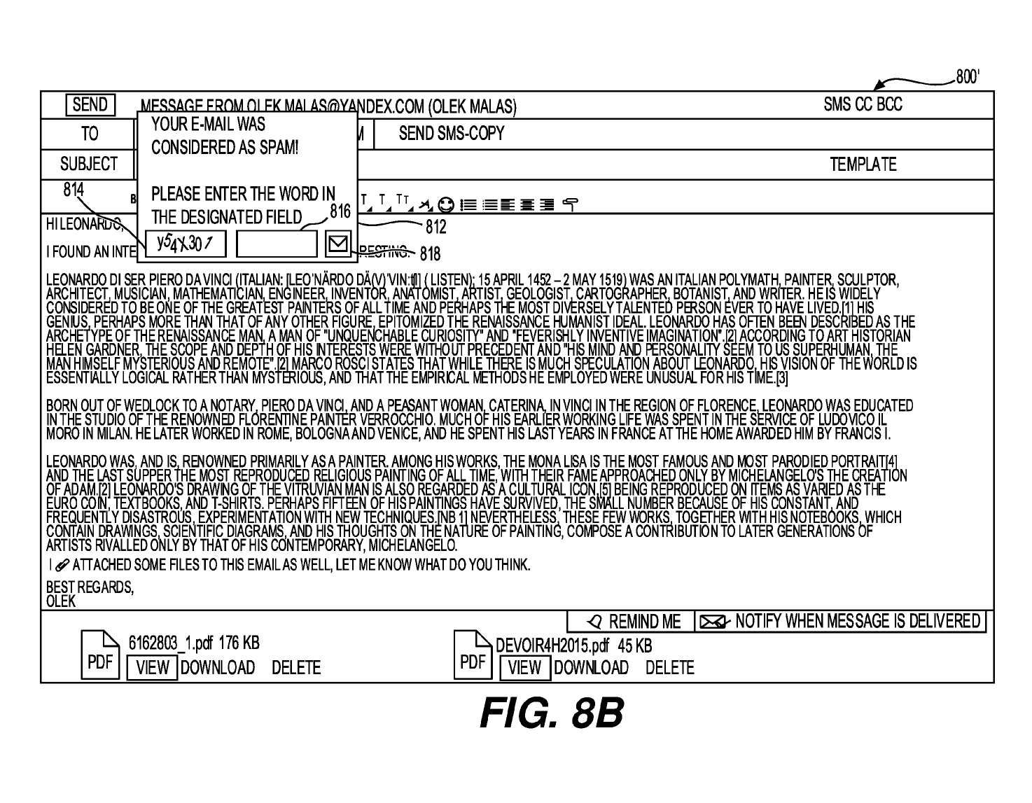

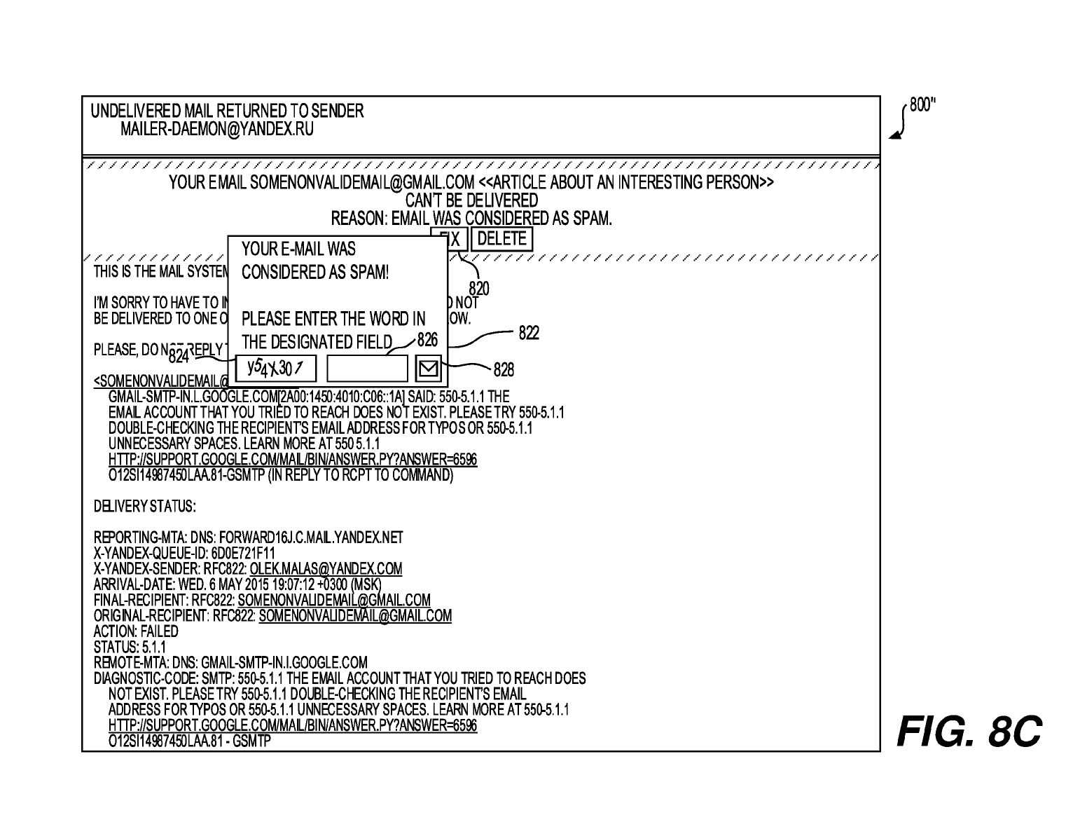

For this example, let's say that the original message bounced because it was considered as spam. The method 500 is executed by the server 106. User 101 is presented with a content representation 801 of a modified electronic message in an inbox view 800, the inbox view being depicted in FIG. 8A, of the mail service executed by server 106, which is displayed in the browser 103 on the electronic device 102. The user 101 may actuate a first interface element 802 for displaying at least one additional indication of a remedial action within the inbox view 800. In some embodiments, the commands for generating the at least one additional indication of the remedial action associated with the first interface element 802 and commands for executing different actions that the user 101 may select following the display of the at least one additional indication of the remedial action are comprised in the modified electronic message and already have been transmitted within data packet 160 to the electronic device 102. In this case, a floating graphical element 804 is generated and displayed directly following the actuation of the first interface element 802 upon the execution of the command to do so responsive to the actuation of the first interface element 802.

In further embodiments, the indication 170 of the user 101 actuating the interface element 802 is sent by the electronic device 102, via the communication network 104, to the server 106. Responsive to the indication 170, the server 106 may transmit the trigger 190 comprising commands for generating and displaying the at least one additional indication of the remedial action associated with the first interface element 802 and commands for executing different actions that the user 101 may select following the display of the at least one additional indication of the remedial action.

As a result, the floating graphical element 804 is generated and displayed within the inbox view 800. The floating graphical element 804 may appear on the right, on the left, over, under or in any position that is in proximity with the content representation 801 of a modified electronic message and\or the first interface element 802 within the inbox view 800. The floating graphical element 804 may also appear in any other position within the inbox view 800. The floating graphical element 804 may comprise an informational snippet for indicating to user 101 that she may enter the recognised CAPTCHA characters from the CAPTCHA field 806 in the CAPTCHA box 808. A send button 810 may also be displayed within the floating graphical element 804 so that user 101 may re-send the original message that bounced.

In another embodiment, upon actuation of the first interface element 802 by the user 101, the server 106 may send the trigger 190 comprising commands for displaying the original electronic message 800′ (depicted in FIG. 8B) that caused the bounced message, the original electronic message 800′ being displayed in a user-editable form, and commands for executing different actions that the user 101 may select following the display of the original electronic message 800′. Additionally, trigger 190 may comprise further commands for generating and displaying a floating graphical element 812, the floating graphical element 812 being displayed in any position within the original electronic message 800′ being displayed in a user-editable form. The floating graphical element 812 may comprise an informational snippet for indicating to user 101 what can be done for remediating the non-delivery of the original electronic message 800′. In this example, user 101 is indicated to enter the recognised CAPTCHA characters from the CAPTCHA field 814 in the CAPTCHA box 816 and to re-send the original electronic message 800′ by actuating the send button 818. In other embodiments, the commands comprised in the trigger 190 may generate the informational snippet as well as the CAPTCHA field 814 and CAPTCHA box 816 directly within the message body of the original electronic message 800′ instead of generating the floating graphical element 812. In this case, the send button 818 may be generated in the upper left corner of the original electronic message 800′ as a standard send button.

It should be noted that the floating graphical element 812 may be rather embedded within the message body of the original electronic message 800′ as opposed to floating over at least some content of the original electronic message 800′. In yet other embodiments, the commands for generating the at least one indication of the remedial action associated with the first interface element 802 and commands for executing different actions that the user 101 may select following the display of the at least one additional indication of the remedial action are comprised in the modified electronic message and already have been transmitted within data packet 160 to the electronic device 102. In this case, the original electronic message 800′ and the floating graphical element 812 (or embedded) are displayed directly following the actuation of the first interface element 802, upon the execution of the commands to do so responsive to the actuation of the first interface element 802, without the need of sending the indication 170 and receiving the trigger 190 from server 106.

Moreover, the user 101 may select to click on the content representation 801 of a modified electronic message in the inbox view 800 instead of actuating the first interface element 802. In this case, commands within the data packet 160 may display a content representation 800″ of the modified electronic message depicted in FIG. 8C and the user 101 will be presented therewith on the electronic device 102. Upon actuation the first interface element 820, the indication 170 of the user 101 actuating the first interface element 820 is sent to the server 106. Responsive to the indication 170, the server 106 may transmit the trigger 190 comprising commands for generating and displaying at least one additional indication of a remedial action associated with the first interface element 820 and commands for executing different actions that the user 101 may select following the display of the at least one additional indication of the remedial action.

As a result, a floating graphical element 822 is generated and displayed within the content representation 800″ of the modified electronic message. The floating graphical element 822 may appear on the right, on the left, over, under or in any position that is in proximity with the first interface element 820 within the content representation 800″ of the modified electronic message. Also, the floating graphical element 822 may be displayed in any other position within the content representation 800″ of the modified electronic message. The floating graphical element 822 may comprise an informational snippet for indicating to user 101 that she may enter the recognised CAPTCHA characters from the CAPTCHA field 824 in the CAPTCHA box 826. A send button 828 may also be displayed within the floating graphical element 822 so that user 101 may re-send the original message that bounced.

In further embodiments, the commands for generating the at least one indication of the remedial action associated with the first interface element 820 and commands for executing different actions that the user 101 may select following the display of the at least one additional indication of the remedial action are comprised in the modified electronic message and already have been transmitted within data packet 160 to the electronic device 102. In this case, the floating graphical element 822 is generated and displayed directly following the actuation of the first interface element 820, upon the execution of the command to do so responsive to the actuation of the first interface element 820, without the need of sending the indication 170 and receiving the trigger 190 from server 106.

### Scenario 3: Too Large for the Recipients' Inbox

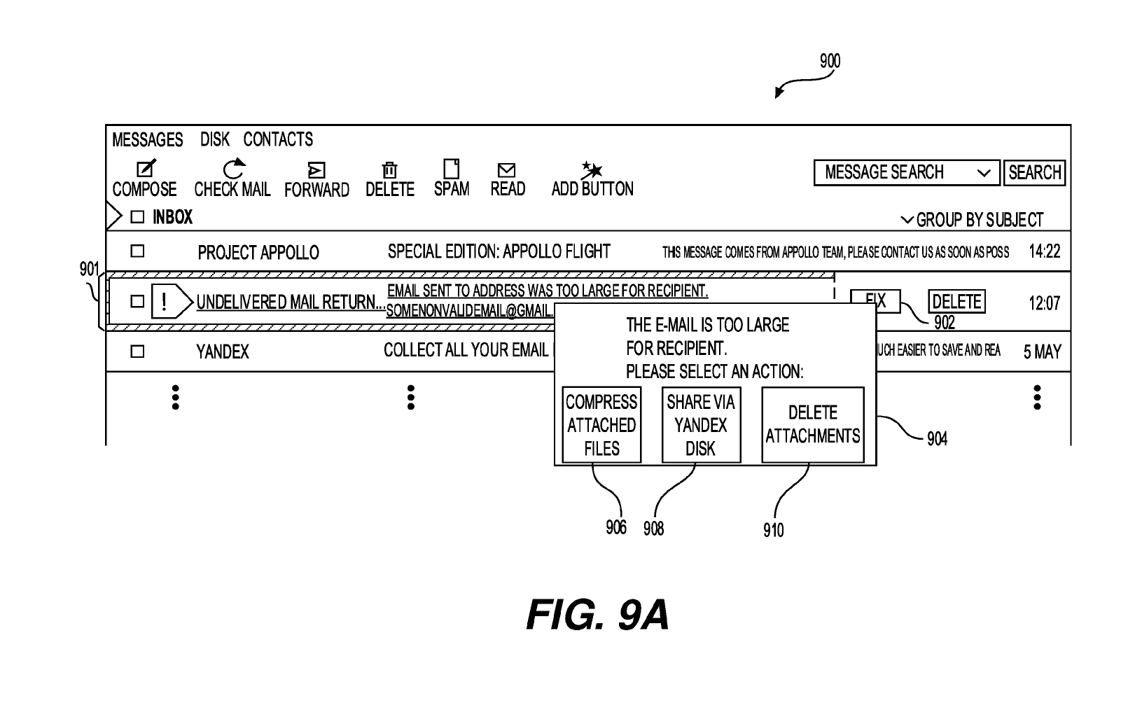

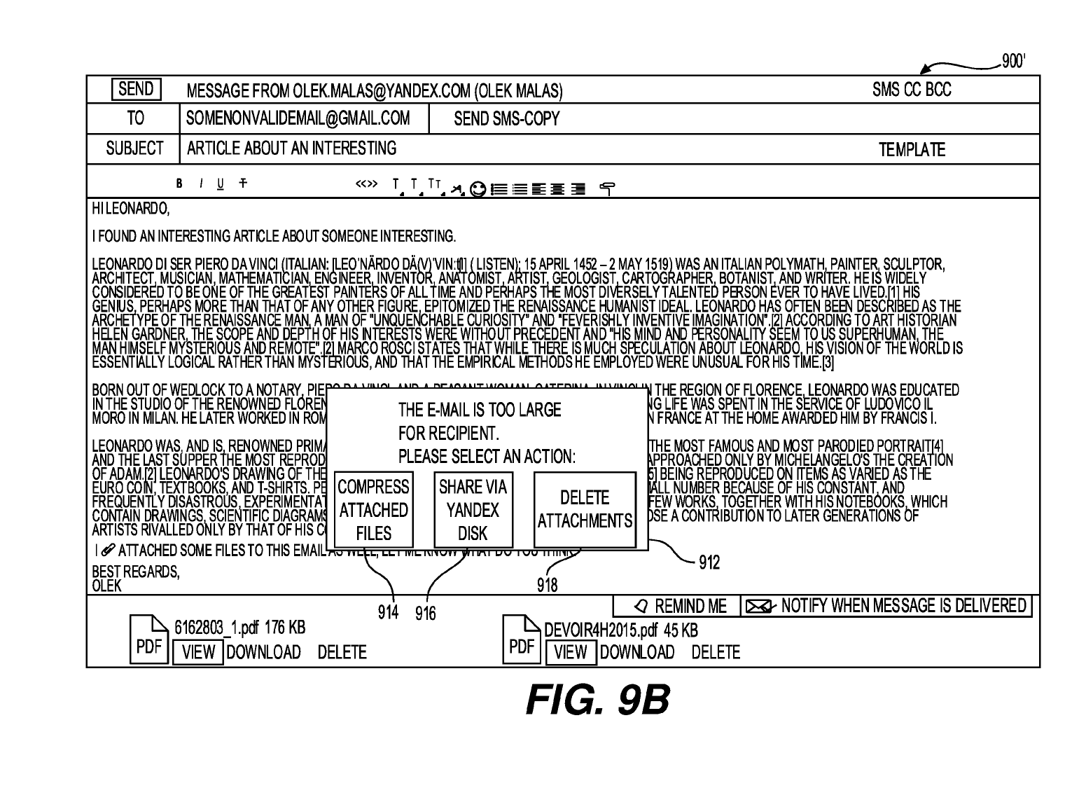

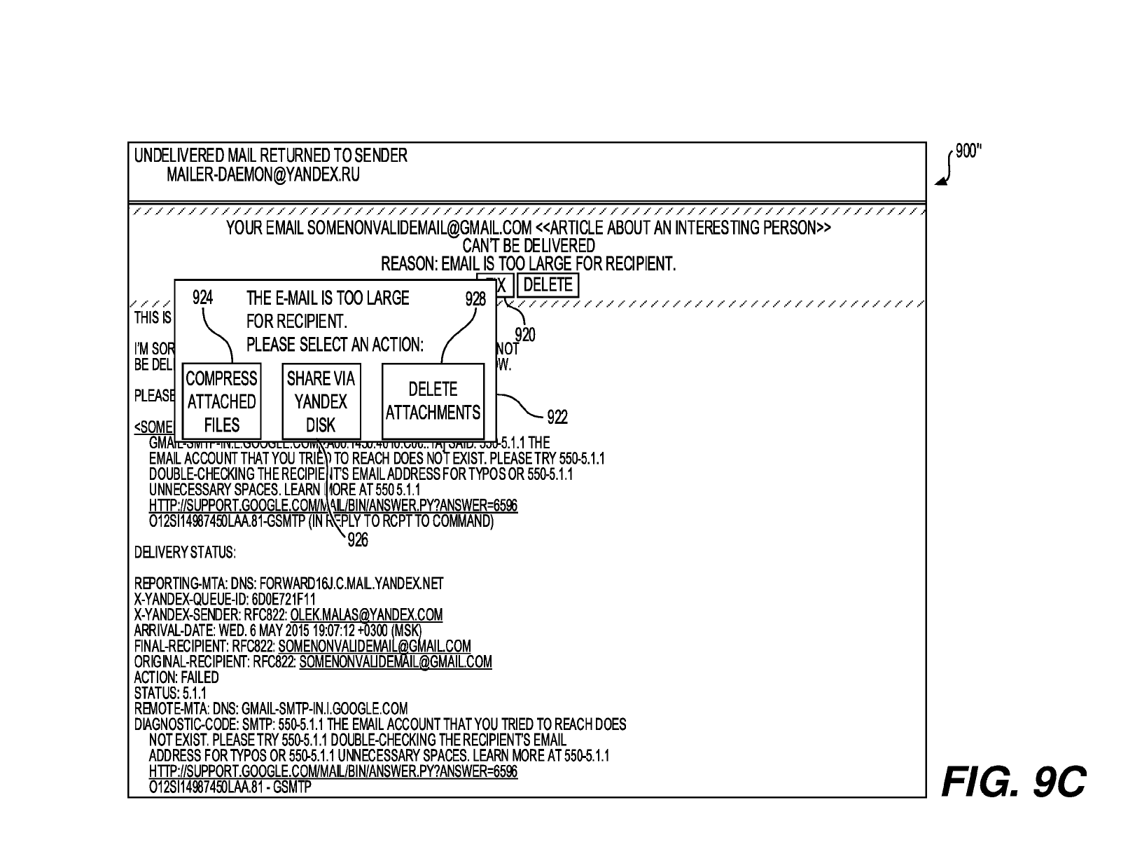

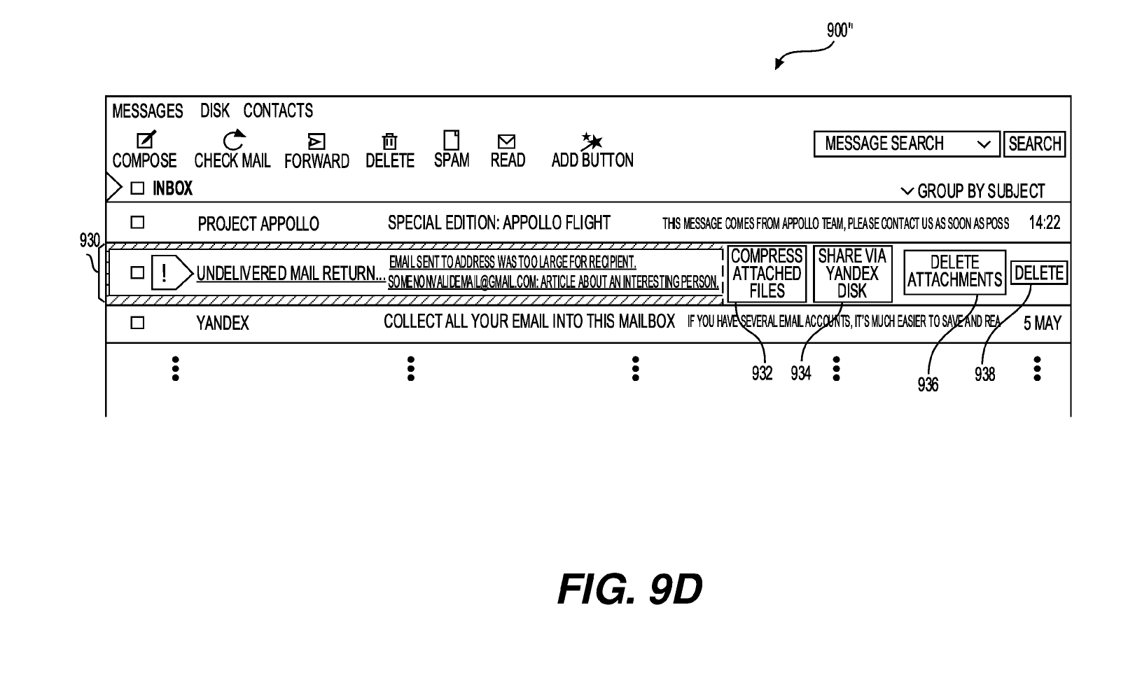

For this example, let's say that the original message bounced because it was considered too large for the recipients' inbox. The method 500 is executed by the server 106 User 101 is presented with a content representation 901 of a modified electronic message in an inbox view 900, the inbox view 900 being depicted in FIG. 9A, of the mail service executed by server 106, which is displayed in the browser 103 on the electronic device 102. User 101 may actuate a first interface element 902 for displaying at least one additional indication of remedial actions within the inbox view 900. In some embodiments, the commands for generating the at least one additional indication of the remedial actions associated with the first interface element 902 and commands for executing different actions that the user 101 may select following the display of the at least one additional indication of the remedial actions are comprised in the modified electronic message and already have been transmitted within data packet 160 to the electronic device 102. In this case, a floating graphical element 904 is generated and displayed directly following the actuation of the first interface element 902 upon the execution of the command to do so responsive to the actuation of the first interface element 902.

In further embodiments, the indication 170 of the user 101 actuating the interface element 902 is sent by the electronic device 102, via the communication network 104, to the server 106. Responsive to the indication 170, the server 106 may transmit the trigger 190 comprising commands for generating and displaying the at least one additional indication of the remedial actions associated with the first interface element 902 and commands for executing different actions that the user 101 may select following the display of the at least one additional indication of the remedial actions.

As a result, the floating graphical element 904 is generated and displayed within the inbox view 900. The floating graphical element 904 may appear on the right, on the left, over, under or in any position that is in proximity with the content representation 901 of the modified electronic message and\or the first interface element 902 within the inbox view 900. The floating graphical element 904 may also appear in any other position within the inbox view 900. The floating graphical element 904 may comprise an informational snippet for indicating to user 101 that she may select to compress the attached files via button 906, share via Yandex disk by clicking the button 908 or delete the attachments via button 910. Each button 906, 908 and 910 corresponds to command for executing a respective remedial action determined by the method 500 depicted in FIG. 5.

In another embodiment, upon actuation of the first interface element 902 by the user 101, the server 106 may send the trigger 190 comprising commands for displaying the original electronic message 900′ (depicted in FIG. 9B) that caused the bounced message, the original electronic message 900′ being displayed in a user-editable form, and commands for executing different actions that the user 101 may select following the display of the original electronic message 900′. Additionally, trigger 190 may comprise further commands for generating and displaying a floating graphical element 912, the floating graphical element 912 being displayed in any position within the original electronic message 900′ being displayed in a user-editable form. The floating graphical element 912 may comprise an informational snippet for indicating to user 101 what can be done for remediating the non-delivery of the original electronic message 900′. In this example, user 101 is indicated to select either the compress the attached files button 914, the share via Yandex disk button 916 or delete the attachments button 918. In other embodiments, the commands comprised in the trigger 190 may generate the informational snippet as well as the compress the attached files button 914, the share via Yandex disk button 916 and delete the attachments button 918 directly within the message body of the original electronic message 900′ instead of generating the floating graphical element 912. Each button 914, 916 and 918 corresponds to commands for executing a respective remedial action determined by the method 500 depicted in FIG. 5.

It should be noted that the floating graphical element 912 may rather be embedded within the message body of the original electronic message 900′ as opposed to floating over at least some content of the original electronic message 900′. In yet other embodiments, the commands for generating the at least one indication of the remedial actions associated with the first interface element 902 and commands for executing different actions that the user 101 may select following the display of the at least one additional indication of the remedial actions are comprised in the modified electronic message and already have been transmitted within data packet 160 to the electronic device 102. In this case, the original electronic message 900′ and the floating graphical element 912 (or embedded) are displayed directly following the actuation of the first interface element 902, upon the execution of the command to do so responsive to the actuation of the first interface element 902, without the need of sending the indication 170 and receiving the trigger 190 from server 106.

Moreover, user 101 may click on the content representation 901 of the modified electronic message in the inbox view 900 instead of actuating the first interface element 902. In this case, commands within the data packet 160 may generate a content representation 900″ of the modified electronic message depicted in FIG. 9C and the user 101 will be presented therewith on the electronic device 102. Upon actuation the first interface element 920, the indication 170 of the user 101 actuating the first interface element 920 is sent to the server 106. Responsive to the indication 170, the server 106 may transmit the trigger 190 comprising commands for generating and displaying at least one additional indication of remedial actions associated with the first interface element 920 and commands for executing different actions that the user 101 may select following the display of the at least one additional indication of the remedial actions.

As a result, a floating graphical element 922 is generated and displayed within the content representation 900″ of the modified electronic message. The floating graphical element 922 may appear on the right, on the left, over, under or in any position that is in proximity with the first interface element 920 within the content representation 900″ of the modified electronic message. Also, the floating graphical element 922 may be displayed in any other position within the content representation 900″ of the modified electronic message. The floating graphical element 922 may comprise an informational snippet for indicating to user 101 that he may select to compress the attached files via button 924, share via Yandex disk by clicking the button 926 or delete the attachments via button 928. Each button 924, 926 and 928 corresponds to commands for executing a respective remedial action determined by the method 500 depicted in FIG. 5.

In further embodiments, the commands for generating the at least one indication of the remedial actions associated with the first interface element 920 and commands for executing different actions that the user 101 may select following the display of the at least one additional indication of the remedial actions are comprised in the modified electronic message and already have been transmitted within data packet 160 to the electronic device 102. In this case, the floating graphical element 922 is generated and displayed directly following the actuation of the first interface element 920, upon the execution of the command to do so responsive to the actuation of the first interface element 920, without the need of sending the indication 170 and receiving the trigger 190 from server 106.

In additional embodiments, the server 106 may transmit, via the communication network 104, to the electronic device 102, the modified electronic message within data packet 160 for displaying, within the browser 103, an inbox view 900′″, the inbox view 900′″ being depicted in FIG. 9D, comprising the content representation 930 of the modified electronic message. The data packet 160 may comprise commands for generating each first interface elements 932, 934 and 936, and commands for executing different actions that the user 101 may select following the display of the first interface elements 932, 934 and 936. Each first interface element 932, 934 and 936 is associated to a distinct remedial action determined by the method 500 in FIG. 5. The commands in the modified electronic message within the data packet 160 further generate a second interface element 938 within the inbox view 900′ which is associated to at least one other action. In this case, the at least one other action is deleting the modified electronic message.

In some embodiments, upon actuating one of the interface elements 932, 934 and 936 the indication 170 of user 101 actuating one of the interface elements 932, 934 and 936 is sent by the electronic device 102, via the communication network 104, to the server 106. Responsive to the indication 170, the server 106 may execute the remedial action associated with one of the interface elements 932, 934 and 936. Additionally, the server 106 may transmit to the electronic device 102, the confirmation 180 of the remedial action associated with one of the interface elements 932, 934 and 936 having been executed.

In alternative embodiments, the commands for executing different remedial actions that the user 101 may select following the display of the first interface elements 932, 934 and 936 are in the modified electronic message and already have been transmitted within data packet 160 to the electronic device 102. In this case, the remedial action associated with one of the actuated interface elements 932, 934 and 936 is executed.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

One skilled in the art will appreciate when the instant description refers to “receiving data” from a user that the electronic device executing receiving of the data from the user may receive an electronic (or other) signal from the user. One skilled in the art will further appreciate that displaying data to the user via a user-graphical interface (such as the screen of the electronic device and the like) may involve transmitting a signal to the user-graphical interface, the signal containing data, which data can be manipulated and at least a portion of the data can be displayed to the user using the user-graphical interface.

Some of these steps and signal sending-receiving are well known in the art and, as such, have been omitted in certain portions of this description for the sake of simplicity. The signals can be sent-received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims

As such, from one perspective, embodiments of the present technology described above can be described as follows, structured in numbered clauses.
CLAUSE 1. A method (500) of processing an electronic message (502), the method executable on a server (106), the server coupled to an electronic device via a communication network (104), the electronic device associated with a user (101), the method comprising:
   receiving (502) the electronic message destined for the user, the electronic message being a bounce message, the electronic message including a content portion that is unintelligible to the user in regard to an indication of an error type that caused the bounce message to have been generated;
   parsing (504) the bounce message by applying at least parsing process to determine the error type;
   based on the error type, determining (506) at least one remedial action associated with the error type.
   generating (508) a modified electronic message, the modified electronic message comprising at least a first interface element for displaying to the user an indication of the remedial action in a form that is intelligible to the user;
   transmitting (510) to the electronic device the modified electronic message.
CLAUSE 2. The method of clause 1, wherein the modified electronic message further comprises at least one of a first portion of the content portion (302) and a second portion of the content portion (310) of the bounce message (300).
CLAUSE 3. The method of clause 1, further comprising:
   receiving from the electronic device an indication (170) of the user actuating the first interface element;
   executing the remedial action in association with the electronic message; and
   transmitting to the electronic device a confirmation (180) of the remedial action having been executed.
CLAUSE 4. The method of clause 1, wherein the first interface element (716) is further configured to display to the user (101) an additional indication (718) of the at least one remedial action, the additional indication (718) of the at least one remedial action being in a form that is intelligible to the user.
CLAUSE 5. The method of clause 3, wherein before executing the remedial action, the method further comprises:
   sending a trigger (190) to the electronic device (102), the trigger (190) for displaying to the user (101) an original electronic message (200), the original electronic message (200) being a message that caused generation of the bounce message (300).
CLAUSE 6. The method of clause 5, the trigger (190) being further configured to cause the electronic device (102) to display the original electronic message in a user-editable form (700′).
CLAUSE 7. The method of clause 5, wherein the trigger (190) is sent as part of the modified electronic message.
CLAUSE 8. The method of any one clause 1 to 7, wherein the error type is at least one of:
   a wrong destination address;
   a rejection as spam;
   an original electronic message exceeding allowed size for a recipient
   an original electronic message containing malware;
   a blocked recipients' e-mail address;
   a full recipients' mailbox;
   a recipients' server error;
   a blocked IP-address
CLAUSE 9. The method of any one clause 1 to 8, wherein the modified electronic message further comprises a second interface element (420) associated with at least one other action.
CLAUSE 10. The method of clause 9, wherein the at least one other action is deleting the modified electronic message.
CLAUSE 11. The method of clause 1, wherein the transmitting (510) to the electronic device the modified electronic message causes the electronic device (102) to display a content representation of the modified electronic message (400) to the user (101), the modified electronic message including the first interface element (418).
CLAUSE 12. The method of clause 1, wherein the transmitting (510) to the electronic device the modified electronic message causes the electronic device (102) to display the first interface element (620) in an inbox view (600), the inbox view (600) displaying at least one indication (609, 610, 611) of the modified electronic message being visually distinguishable from the at least one other electronic message (606).
CLAUSE 13. The method of any one clause 1 to 12, wherein the first interface element (932) is for allowing the user (101) to execute the remedial action directly from the inbox view (900″′) without opening the modified electronic message.
CLAUSE 14. The method of clause 1 further comprising:
   determining that the electronic message is a bounce message (300).
CLAUSE 15. The method of any one clause 1 to 14, generating the modified electronic message further comprises generating commands for displaying at least the first interface element (418).
CLAUSE 16. A server (106) for processing an electronic message, the server (106) comprising a processor and a tangible computer readable storage medium in communication with the processor and storing instructions that cause the server (106) to execute the method of clauses 1 to 15.

1. A method of processing an electronic message, the method executable on a server, the server coupled to an electronic device via a communication network, the electronic device associated with a user, the method comprising:
receiving the electronic message destined for the user, the electronic message being a bounce message, the electronic message including a content portion that is unintelligible to the user in regard to an indication of an error type that caused the bounce message to have been generated;
parsing the content portion of the electronic message that is unintelligible to the user by applying at least a parsing process to determine the error type;
based on the error type, determining at least one remedial action associated with the error type;
generating a modified electronic message based on at least the content portion of the electronic message that is unintelligible to the user, the modified electronic message comprising at least a first interface element for displaying to the user an indication of the remedial action in a form that is intelligible to the user; and
transmitting to the electronic device the modified electronic message.

2. The method of claim 1, wherein the modified electronic message further comprises at least one of a first portion of the content portion and a second portion of the content portion of the bounce message.

3. The method of claim 1, further comprising:
receiving from the electronic device an indication of the user actuating the first interface element;
executing the remedial action in association with the electronic message; and
transmitting to the electronic device a confirmation of the remedial action having been executed.

4. The method of claim 1, wherein the first interface element is further configured to display to the user an additional indication of the at least one remedial action, the additional indication of the at least one remedial action being in a form that is intelligible to the user.

5. The method of claim 3, wherein before executing the remedial action, the method further comprises:
sending a trigger to the electronic device, the trigger for displaying to the user an original electronic message, the original electronic message being a message that caused generation of the bounce message.

6. The method of claim 5, the trigger being further configured to cause the electronic device to display the original electronic message in a user-editable form.

7. The method of claim 5, wherein the trigger is sent as part of the modified electronic message.

8. The method of claim 1, wherein the error type is at least one of:
a wrong destination address;
a rejection as spam;
an original electronic message exceeding allowed size for a recipient;
an original electronic message containing malware;
a blocked recipients' e-mail address;
a full recipients' mailbox;
a recipients' server error;
a blocked IP-address.

9. The method of claim 1, wherein the modified electronic message further comprises a second interface element associated with at least one other action.

10. The method of claim 9, wherein the at least one other action is deleting the modified electronic message.

11. The method of claim 1, wherein the transmitting to the electronic device the modified electronic message causes the electronic device to display a content representation of the modified electronic message to the user, the modified electronic message including the first interface element.

12. The method of claim 1, wherein the transmitting to the electronic device the modified electronic message causes the electronic device to display the first interface element in an inbox view, the inbox view displaying at least one indication of the modified electronic message being visually distinguishable from the at least one other electronic message.

13. The method of claim 1, wherein the first interface element is for allowing the user to execute the remedial action directly from the inbox view without opening the modified electronic message.

14. The method of claim 1 further comprising:
determining that the electronic message is a bounce message.

15. The method of claim 1, wherein generating the modified electronic message further comprises generating commands for displaying at least the first interface element.

16. A server for processing an electronic message, the server comprising
a processor; and
a tangible computer readable storage medium in communication with the processor and storing instructions that cause the processor to:
receive the electronic message destined for the user, the electronic message being a bounce message, the electronic message including a content portion that is unintelligible to the user in regard to an indication of an error type that caused the bounce message to have been generated;
parse the content portion of the electronic message that is unintelligible to the user by applying at least a parsing process to determine the error type;
based on the error type, determine at least one remedial action associated with the error type;
generate a modified electronic message based on the content portion of the electronic message that is unintelligible to the user, the modified electronic message comprising at least a first interface element for displaying to the user an indication of the remedial action in a form that is intelligible to the user;
transmit to the electronic device the modified electronic message.

17. The server of claim 16, wherein the modified electronic message further comprises at least one of a first portion of the content portion and a second portion of the content portion of the bounce message.

18. The server of claim 16, the instructions being further operable to cause the processor to:
receive from the electronic device an indication of the user actuating the first interface element;
execute the remedial action in association with the electronic message; and
transmit to the electronic device a confirmation of the remedial action having been executed.

19. The server of claim 16, wherein the first interface element is further configured to display to the user an additional indication of the at least one remedial action, the additional indication of the at least one remedial action being in a form that is intelligible to the user.

20. The server of claim 18, the instructions being further operable to cause the processor, before executing the remedial action, to:
send a trigger to the electronic device, the trigger for displaying to the user an original electronic message, the original electronic message being a message that caused generation of the bounce message.

21.-30. (canceled)
